(19) United States
(12) Patent Application Publication
(10) Pub. No.: US 2011/0025605 A1
(43) Pub. Date: Feb. 3, 2011

(54) Phase change material hand pads for laptop computers and other electronic devices

(76) Inventor: Benjamin J. Kwitek, Canon City, CO (US)

Correspondence Address: WELSH FLAXMAN & GITLER LLC, 2000 DUKE STREET, SUITE 100, ALEXANDRIA, VA, 22314, US

(21) Appl. No.: 12/588,375

(22) Filed: Oct. 14, 2009

Related U.S. Application Data
(63) Continuation-in-part of application No. 11/024,766, filed on Dec. 30, 2004, now abandoned.
Application No. 11/024,766 is a continuation-in-part of application No. 10/458,256, filed on Jun. 11, 2003, now Pat. No. 6,963,486.
(60) Provisional application No. 60/533,259, filed on Dec. 31, 2003.
(60) Provisional application No. 60/388,367, filed on Jun. 14, 2002.

(51) Int. Cl. G06F 3/02

(52) U.S. Cl. 345/168

(57) ABSTRACT

A laptop computer includes a one-piece, unitary keyboard housing and a monitor. The keyboard housing supports a plurality of keys for manipulation by a user of the computer. At least one hand pad is selectively secured to the keyboard housing. The at least one hand pad is positioned adjacent the plurality of keys for supporting the hand of a user as the user manipulates the plurality of keys. The hand pad is a substantially flat pad. The pad includes a bottom surface shaped and dimensioned to rest firmly upon the keyboard housing and a top surface contoured to comfortably support a hand of a user. The hand pad also includes a phase change material incorporated therein, the phase change material absorbing and storing heat for later release in a manner providing a user with a sensation of coolness as he or she places fingers, hands or arms on the hand pad to provide a comfortable temperature pleasing to a user.

### CROSS REFERENCE TO RELATED APPLICATIONS

This application is a continuation-in-part of U.S. patent application Ser. No. 11/024,766, filed Dec. 30, 2004, entitled “PHASE CHANGE MATERIAL HAND PADS FOR LAPTOP COMPUTERS AND OTHER ELECTRONIC DEVICES”, which is currently pending, which claims the benefit of U.S. Provisional Patent Application Ser. No. 60/533,259, filed Dec. 31, 2003, entitled “HAND PADS FOR LAPTOP COMPUTERS AND OTHER ELECTRONIC DEVICES”, and U.S. patent application Ser. No. 11/024,766, filed Dec. 30, 2004 is a continuation in part of U.S. patent application Ser. No. 10/458,256, filed Jun. 11, 2003, entitled “HAND PADS FOR LAPTOP COMPUTERS AND OTHER ELECTRONIC DEVICES”, which is now U.S. Pat. No. 6,963,486 issued Nov. 8, 2005, which is based upon U.S. Provisional Application Ser. No. 60/388,367, entitled “HAND PADS FOR LAPTOP COMPUTERS AND OTHER ELECTRONIC DEVICES”, filed Jun. 14, 2002. In addition, the present application relates to U.S. Pat. No. 6,336,614, entitled “CONFORMABLE PORTABLE COMPUTER HAND PADS”, which issued Jan. 8, 2002 and U.S. Pat. No. 6,963,486, entitled “HAND PADS FOR LAPTOP COMPUTERS AND OTHER ELECTRONIC DEVICES”, which issued Nov. 8, 2005.

### BACKGROUND OF THE INVENTION

1. Field of the Invention

This invention relates to ergonomic hand pads for laptop computers and other electronic devices. More particularly, the invention relates to ergonomic hand pads utilizing phase change material coatings, fabrics, foams and other materials to enhance user comfort when employing the present hand pads.

2. Background of the Invention

The use of computer input devices such as computer keyboards, mice, tracking pads and other similar devices is becoming increasingly prevalent in modern computing. However, continuous use of these input devices is often uncomfortable, and sometimes hazardous to the user. For example, use of keyboards, mice and tracking pads require positioning the user's hand in a generally horizontal position which can cause the tendons in the hand to lie in a strained position, often resulting in discomfort.

Simple flat pads are currently available for supporting a user's hand as he or she manipulates the input devices or desktop computers. Such pads have been further refined to provide contoured surfaces on which to support the user's hand.

Unfortunately, these prior attempts have been met with only limited success, since they often fail to conform to a specific user's hands and, therefore, only offer limited relief from the pressures being applied as the user manipulates his or her input device. These devices also were designed for desktop computers and full size keyboards.

In addition, prior art pads suffer from problems associated with the soft fabric covers used in conjunction with the pads. For example, it is difficult to protect the underlying gel material from outside elements, for example, sunshine, sharp objects, beverages, food, perspiration, hand oils, cosmetics, lotions and perfumes etc. Additionally, the base materials or gels may be too tacky, oily or sticky for direct contact with human skin.

Current pads use covering fabrics such as LYCRA. Although LYCRA provides users with a nonstick and nonoily surface to rest his hands, wrists or arms, LYCRA does not address the problems discussed above. Ultimately, the gel pad materials utilized as in the hand pads must provide comfort despite constant pressure, movement and use when the fabric material becomes warm, sweaty and uncomfortable. A need, therefore, exists for a computer pad offering users a soft and individually conforming hand surface that remains comfortable by regulating temperature. The present invention provides such a computer hand pad.

### SUMMARY OF THE INVENTION

It is, therefore, an object of the present invention to provide a laptop computer including a one-piece, unitary keyboard housing and a monitor. The keyboard housing supports a plurality of keys for manipulation by a user of the computer. At least one hand pad is selectively secured to the keyboard housing. The at least one hand pad is positioned adjacent the plurality of keys for supporting the hand of a user as the user manipulates the plurality of keys. The hand pad is a substantially flat pad. The pad includes a bottom surface shaped and dimensioned to rest firmly upon the keyboard housing and a top surface contoured to comfortably support a hand of a user. The hand pad also includes a phase change material incorporated therein, the phase change material absorbing and storing heat for later release in a manner providing a user with a sensation of coolness as he or she places fingers, hands or arms on the hand pad to provide a comfortable temperature pleasing to a user.

It is also an object of the present invention to provide a laptop wherein the hand pad is a viscoelastic solid-phase material.

It is another object of the present invention to provide a laptop wherein the viscoelastic solid-phase material is a thermoplastic elastomer.

It is a further object of the present invention to provide a laptop wherein the viscoelastic material is a viscous liquid material contained within an elastomeric bag.

It is also an object of the present invention to provide a laptop wherein the phase change material is incorporated in the coating on the pad.

It is another object of the present invention to provide a laptop wherein the coating is a fabric, leather or foam having phase change material incorporated therein.

It is a further object of the present invention to provide a laptop wherein the pad includes a core, and the phase change material is incorporated in the core of the pad.

It is also an object of the present invention to provide a laptop wherein the hand pad also includes an adhesive layer applied to the bottom surface allowing for ready attachment to the laptop housing.

It is also an object of the present invention to provide a hand pad adapted for selective attachment to, integrated into the case, or use with a laptop computer, personal digital assistant or other electronic devices. The hand pad includes a flat viscoelastic pad including a bottom surface shaped and dimensioned to rest firmly upon a machine housing and a top surface contoured to comfortably support or grip a hand of a user. The pad includes materials such as phase change materials, natural materials or similar synthetic materials providing a user with a pleasant sensation or a feeling of coolness as he or she places fingers, hands or arms on the hand pad.

It is a further object of the present invention to provide a hand pad wherein the pad is a leather or synthetic leather material.

It is also an object of the present invention to provide a hand pad wherein an adhesive layer is applied to the bottom surface of the pad, the adhesive allowing for ready attachment of the pad to the laptop housing

It is another object of the present invention to provide a hand pad including a release sheet covering the adhesive layer such that the adhesive layer may be protected until such a time that one desires to apply the pad to the laptop computer, personal digital assistant or other electronic device.

It is also an object of the present invention to provide a laptop computer including a case surrounding the display panel, a case structure below and around the keyboard housing and input device. The laptop computer also includes at least one hand or finger pad selectively secured to the case where the user rests his or her hands or grabs the computer. The hand or finger pad is a substantially flat pad, the pad includes a bottom surface shaped and dimensioned to rest firmly upon the case and a top surface designed to comfortably support a hand or fingers of a user and for additional comfort and tactile benefits.

It is also an object of the present invention to provide a hand pad adapted for selective attachment to or use with a laptop computer, personal digital assistant or other electronic devices. The hand pad includes a flat viscoelastic pad including a bottom surface shaped and dimensioned to rest firmly upon a machine housing and a top surface contoured to comfortably support a hand of a user. The pad includes a bottom surface shaped and dimensioned to rest firmly upon the keyboard housing and a top surface contoured to comfortably support a hand of a user and regulate the temperature of the hand pad as a user places fingers, hands or arms on the hand pad, and the top surface is leather or synthetic leather.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a top view of a hand pad constructed from a solid, soft, viscoelastic material.

FIG. 2 is a cross sectional view of the hand pad disclosed in FIG. 1.

FIG. 3 is a cross-sectional view of an alternate embodiment of a hand pad comprising a gelatinous material interposed within a more resilient material.

FIG. 4 is a top view of hand pads attached to the top surface of a laptop computer keyboard.

FIGS. 5 to 9 disclose a variety of hand pad shapes contemplated for use in accordance with the present invention.

FIGS. 10 and 11 are detailed cross sectional views showing embodiments of the coating in accordance with the present invention.

FIGS. 12 and 13 are cross sectional views of the hand pad in accordance with alternate embodiments thereof.

### DESCRIPTION OF THE PREFERRED EMBODIMENTS

The detailed embodiment of the present invention is disclosed herein. It should be understood, however, that the disclosed embodiment is merely exemplary of the invention, which may be embodied in various forms. Therefore, the details disclosed herein are not to be interpreted as limited, but merely as the basis for the claims and as a basis for teaching one skilled in the art how to make and/or use the invention.

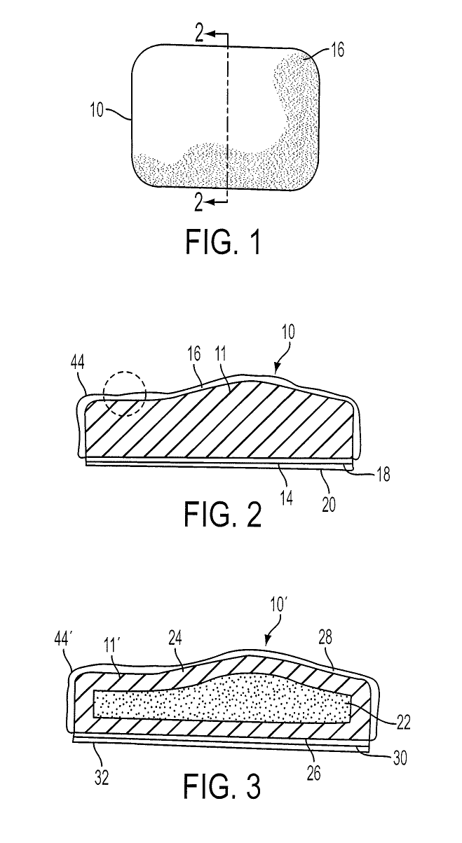

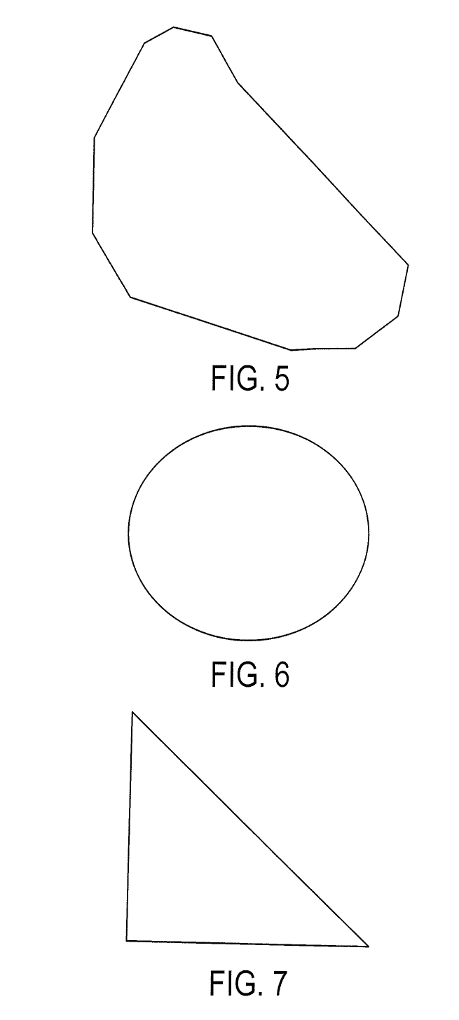

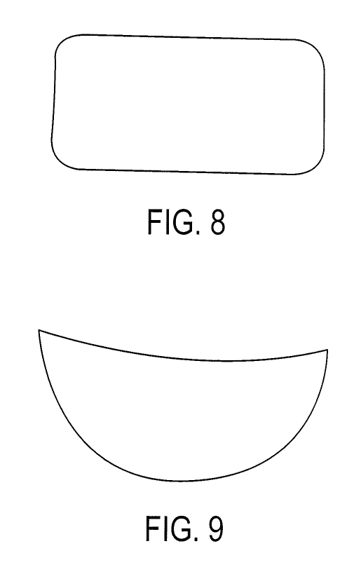

With reference to FIGS. 1 to 13, the various embodiments of the present invention are disclosed. Since many elements are similar in the various embodiments disclosed herein, similar reference numerals have been used herein as deemed appropriate. FIG. 1 shows a top view of a responsive, viscoelastic solid hand pad 10 utilized in accordance with the present invention and FIG. 2 shows a cross-sectional view of the same hand pad. As discussed above, the present hand pad 10 is designed for use with laptop computers, personal digital assistants, tablet-type computers and other electronic devices. However, the present disclosure will focus upon its use in conjunction with laptop computers, although those skilled in the art will certainly appreciate the manner in which the following teachings may be applied in the use of other electronic devices.

The hand pad 10 provides a comfortable and pleasing surface on which the user may rest his or her hands while typing or operating a mouse, or similar tracking device. The materials used for the hand pad 10 provide a soft and smooth surface for the user's hands. Preferably, the hardness of the materials used for the hand pad, as measured by a Shore A Durometer, is less than 75.

Referring again to FIGS. 1, 2 and 5 through 9, a flat viscoelastic, solid hand pad 10 is shown. The hand pad 10 may take a variety of shapes depending upon the support surface provided on the laptop computer 12, or other electronic device, to which it is attached, and those skilled in the art will appreciate the many shapes which may be utilized within the spirit of the present invention.

The hand pad 10 includes a bottom surface 14 and a top surface 16. The bottom surface 14 is generally flat such that the hand pad 10 may be selectively positioned to rest firmly on a flat support surface. The top surface 16 is a generally smooth shape, perhaps also including a natural or artificial texture. This top surface 16 shifts to conform with the applied shape when the weight of the user's hands is applied thereon. The top surface 16 may also be contoured by design to comfortably match the surface of a user's hand which will rest on the top surface 16 while the user types or operates a mouse.

An adhesive layer 18 is secured to the bottom surface 14 of the hand pad 10. The adhesive layer 18 allows for ready attachment of the hand pad 10 to a laptop computer 12. A release sheet 20 protects the adhesive layer 18. The release sheet 20 is placed over the adhesive layer 18 and remains secured to the adhesive layer 18 until it is selectively removed by a user prior to attaching the hand pad 10 to the laptop computer 12.

The adhesive layer 18 is designed/engineered so that it will not damage the flat surface of the laptop computer 12. In accordance with a preferred embodiment, the adhesive layer 18 is selected to permit selective attachment and release of the hand pad 10. The user may, therefore, remove and reposition the hand pads 10 along the surface of the laptop computer housing. While a selectively releasable adhesive layer 18 is disclosed in accordance with a preferred embodiment of the present invention, it is contemplated that a substantially non-releasable adhesive layer or other mechanical or chemical means to fasten the pads may be employed in accordance with alternate embodiments.

In accordance with the embodiment disclosed in FIGS. 1 and 2, the viscoelastic solid hand pad 10 preferably includes a core 11 composed of a viscoelastic solid-phase polymer material. The viscoelastic solid-phase polymer material is preferably a styrenic thermoplastic elastomer containing, for example, KRATON, which is manufactured by Shell Chemical Company. Other viscoelastic materials which may be used are C-FLEX (which contains silicone), TECHNOGEL or SANTOPRENE. It should be appreciated that the styrenic thermoplastic elastomer containing, for example, KRATON, may be altered via chemical and manufacturing processes. This alteration would likely include the softening of the thermoplastic elastomer. The level of tack, especially on the top surface may also be moderated through the use of talc and other products. Other treatments may be used without departing from the spirit of the present invention. Where the core 11 of the viscoelastic solid hand pad 10 is formed from a responsive, and relatively viscoelastic solid-phase polymer material, the outer surfaces of the core 11 of the viscoelastic solid hand pad 10 are formed from the same viscoelastic material as the remainder of the core 11 of the viscoelastic solid hand pad 10.

In accordance with a preferred embodiment of the present invention, the core 11 of the hand pad 10 is formed via an injection molding process. The core 11 of the hand pad 10 is formed to be very thin so as to not drastically change the profile of the laptop computer's housing to which they are applied. In addition, the hand pads 10 should be thin enough that they do not interfere with closing of the laptop case or computer screen. With this in mind, and in accordance with a preferred embodiment of the present invention for use with laptop computers, the thickness should be no greater than approximately 5.00 mm and perhaps as thin as approximately 0.25 mm. However, and as those skilled in the art will appreciate, the thickness may be as much as 10 cm where the pad is utilized in different applications.

The viscoelastic hand pad 10 is further provided with a coating 44 adapted for enhanced user contact. In accordance with a preferred embodiment, the coating 44 is a fabric, for example, LYCRA, or leather or synthetic leather having phase change material incorporated therein. In addition to fabrics or leather, the coating 44 may be a foam with phase change material incorporated therein. As those skilled in the art will certainly appreciate, the phase change material may be incorporated in other polymers, especially those with viscoelastic properties. In accordance with a preferred embodiment of the present invention, OUTLAST phase change material is utilized and functions to help in regulating the temperature of the fabric or other cover material.

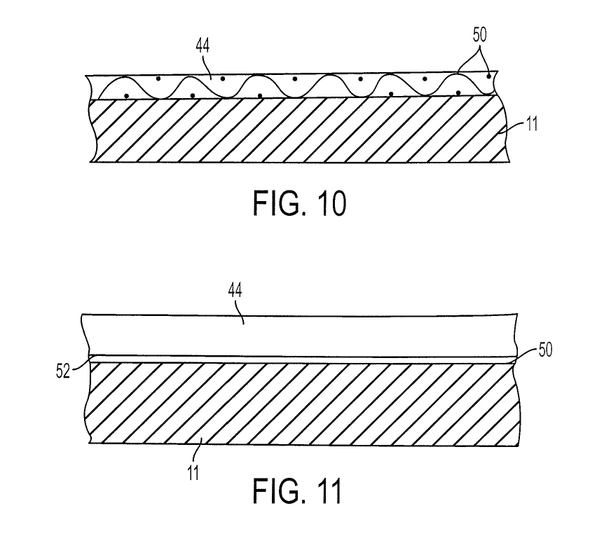

In accordance with a preferred embodiment of the present invention, the phase change materials are bonded, coated or otherwise attached to the fabric, leather, foam or other polymer material. For example, and with reference to FIG. 10, the phase change material 50 may be formed in a strand like structure and woven into the fabric or leather 44. In accordance with an alternate embodiment as shown with reference to FIG. 11, the phase change material might also be formed as a film 50 and applied to a back surface 52 of the fabric or leather so it is positioned between the core 11 and the coating 44. The fabric, foam or other material is then used to cover the gel or gel-like materials. The phase change materials on, and in, the fabric absorb heat from the user's hands and store the energy. This energy is later released to moderate the temperature of the unused hand pads 10. The phase change materials give the user an immediate sensation of coolness as he or she places their fingers, hands or arms on the hand pads 10. This comfortable temperature is assisted and maintained during the use of the hand pads 10. This cooler temperature pleases the user and reduces perspiration.

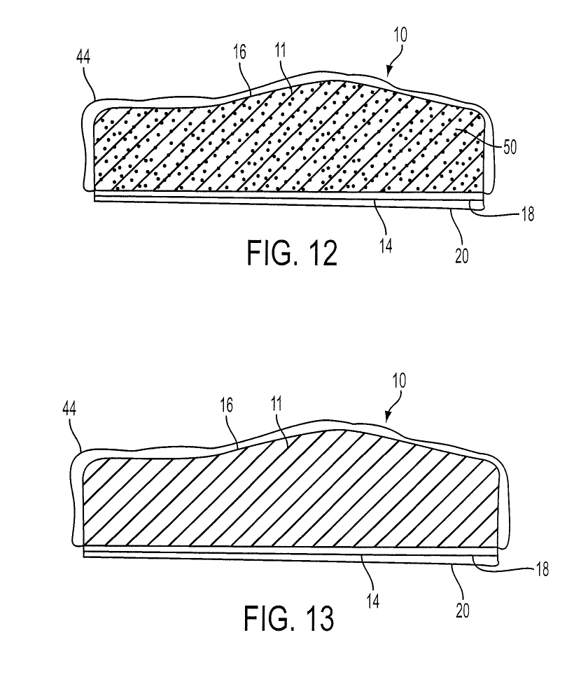

In accordance with yet a further embodiment of the present invention, and with reference to FIG. 12, the phase change materials 50 may be incorporated into the gel core 11 of the hand pads 10. Alternatively, it is contemplated the phase change material can be mixed with a base polymer or coating and applied directly to the outer surface of the hand pad core. The phase change materials may also be mixed with other plastics and then molded or extruded into the final shape of the core. In this way, the phase change materials are dispersed into the entire core of the hand pad.

In accordance with another embodiment disclosed with reference to FIG. 13, the viscoelastic solid hand pad 10 preferably includes a core 11 composed of a viscoelastic solid-phase polymer material as discussed above. The viscoelastic hand pad 10 may further be provided with a leather, or synthetic leather, surface 44 adapted for enhanced user contact. Because of the temperature regulating characteristics offered by leather it would function in a manner similar to the phase change materials discussed above. As a result, the leather would replace the phase change material in providing a structure for regulating the apparent temperature of the leather as a user places his or her hands or fingers upon the hand pad.

It is believed that the utilization of phase change materials in conjunction with hand pads as described above may provide significant benefits to desk top/office ergonomic devices and technologies. It is contemplated that phase change materials may also be utilised in other ergonomic and soft touch products in a similar fashion to the ergonomic hand pads described herein. For example, these products and applications could include sporting good grips and equipment, household and kitchen products, automotive parts and accessories and tools and power equipment. Any product with a grip or handle provides a possible use for this technology. This is especially true for products involving a lot of human hand interaction. In addition, the use of phase change materials with ergonomic and soft touch products improves the interaction between any human/animal and various equipment/machines/electronics or accessories. These applications benefit from the moderated temperatures and reduced perspiration that phase change materials can provide. For example, a thin gel strip could be attached to a strip of phase change material coated fabric. This grip could then be gripped around a piece of sports equipment such as a tennis racquet or golf club. In addition to providing comfort, the phase change material fabric would absorb moisture while maintaining a more pleasant surface temperature for the user.

In accordance with an alternate embodiment of the present invention, and as shown in FIG. 3, the viscoelastic solid-phase polymer construction disclosed with reference to FIGS. 1 and 2 is replaced with a viscous liquid material 22 contained in an elastomeric bag 24. Specifically, and with reference to FIG. 3, the viscoelastic gelatinous hand pad 10′ is composed of a core 11′ including viscous liquid material 22 contained in an elastomeric bag 24. The hand pad 10′ also includes a cover 44′ as described above with reference to the other embodiment. The viscous liquid 22 is preferably a silicone gel or oil and the elastomeric bag 24 is preferably a silicone sheet or a thermoplastic elastomer. While preferred materials are disclosed above, other materials exhibiting similar properties may be used without departing from the spirit of the present invention.

As with the embodiment disclosed with reference to FIGS. 1 and 2, the hand pad 10′ disclosed with reference to FIG. 3 includes a bottom surface 26 and a top surface 28. The bottom surface 26 is generally flat, such that the hand pad 10′ rests firmly on a flat support surface. The top surface 28 is contoured to comfortably match the surface of a user's hand which will rest on the top surface 28 while the user types or operates a mouse. An adhesive layer 30 is secured to the bottom surface 26 of the hand pad 10′. The adhesive layer 30 allows for ready attachment of the hand pad 10′ to a laptop computer 12. Protection of the adhesive layer 30 is achieved by placing a release sheet 32 over the adhesive layer 30. The release sheet 32 will remain secured to the adhesive layer 30 until it is selectively removed by a user prior to attaching the hand pad 10′ to the laptop computer 12.

As with the embodiment described above with reference to FIGS. 1 and 2, phase change materials are incorporated within the cover 44′ and/or the core 11′, either the viscous liquid material 22 and/or the elastomeric bag 24.

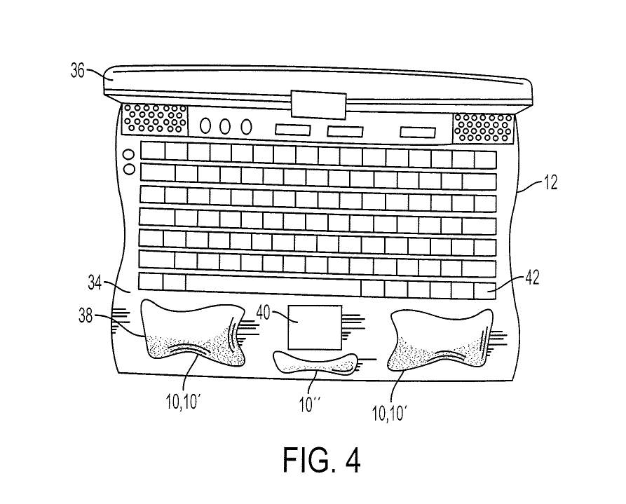

FIG. 4 shows two hand pads 10, 10′ (any of the embodiments disclosed above may be employed a shown herein) used in conjunction with a laptop computer 12 having a keyboard housing 34 and a monitor 36. The first and second hand pads 10, 10′ are strategically positioned on the top 38 of a keyboard housing 34 of the laptop computer 12, adjacent the side of the keyboard housing 34 where the user positions his or her hands for typing. The hand pads 10, 10′ are secured to the housing 34 by simply removing the release sheet 20, 32, identifying the location upon the housing 34 a user wishes to place the hand pads 10, 10′, and pressing the adhesive layer 18, 30 onto the housing 34 so as to secure the hand pads 10, 10′ thereto. The material might also be formulated to stick or attach to the laptop computer without an adhesive but with surface tack or static charge. It is also contemplated the hand pads may be integrally formed with the keyboard housing.

In accordance with a preferred embodiment as disclosed with reference to FIG. 4, one hand pad 10, 10′ is located on each side of a tracking pad 40 located on the top of the keyboard housing 34 adjacent the user. The hand pads 10, 10′ are positioned adjacent the lowest row of keys 42 on the keyboard housing 34, or other input device. The strategic placement of the hand pads 10, 10′ enables a user to rest his or her hands on the hand pads 10, 10′ while typing and using the tracking pad 40. An additional hand pad 10″ is also positioned in front of the tracking pad 40, or other input device.

The soft hand pads 10, 10′ may be used in various locations around the laptop computer 12, notebook, tablet computer or other electronic device. In particular, the soft material is located where the user's fingers, hands, wrists or forearms touch the machine. The soft material provides additional comfort and ergonomics while providing the user with a quality, tactile feel. Some anticipated areas for the soft material include, but are not limited to, the palm rest areas in front of the keyboard and input device on the surface of the laptop computer, the front, side and back edges of the laptop/notebook/tablet computer or other electronic device and the exterior cover and base of the laptop/notebook/tablet computer or other electronic device. Placement on the exterior cover and base is particularly useful in tablet computers where the user's hands and arms hold the exterior of the machine while using the LCD tablet screen for writing.

In addition to providing support for the user's hands while they rest upon the keyboard housing, it is also contemplated that the hand pads will provide insulation helping to maintain the laptop computer at a desired temperature. The viscoelastic materials disclosed here also absorb shock and vibration from the operation of the laptop computer. This becomes particularly advantageous when the laptop computer is being used on an aircraft or train.

As briefly discussed above, both thermosetting materials (for example, silicone) and thermoplastic materials (for example, KRATON and SANTOPRENE) offer advantages and may be combined for producing the most useful hand pads. With regard to thermosetting materials, the thermoset gel materials, such as silicone, could be used in the following fashion. A thin layer (0.25 mm to 5.0 mm) of the gelatinous material could be cut or molded via a liquid pour into the desired shape. It is likely that this material would be treated with additional chemicals or processes to obtain the desired form and feel. The softness of these gel materials would be less than Shore A 75 and most likely less than 50.

It is expected that this soft thermoset gel would be contained within an elastomeric bag or covering. For example, a very thin (0.10 mm to 1.0 mm) cover sheet could be formed or sealed around the gel material. This cover could be formed from a durable material such as polycarbonate or polyurethane. This cover material would be strong but flexible. It could be easily cleaned and would provide a smooth surface for the user's hands.

As briefly discussed above, it is contemplated the thermoplastic materials, such as KRATON and SANTOPRENE, could be injection molded into the desired shapes. These shapes could include various width, height and depth variations. For placement on laptop/notebook/tablet computer or electronic devices, the thermoplastic material would be quite thin (0.25 mm to 5.0 mm) depending on the placement. It is also possible that two different thermoplastics could be comolded or overmolded to provide for the desired shape and function. The softness of these thermoplastics would be less than Shore A 55 and would most likely include materials of approximately 0-30 Shore A Durometer.

Further to the preferred embodiments disclosed above, it is contemplated soft hand pads may be applied to laptop/notebook/tablet computers or electronic devices in other ways. For example, it is contemplated the soft hand pads could be attached in at least four distinct ways. First, the pad materials could be overmolded or comolded with the native plastics or metals on the surfaces of the laptop computer or other electronic device. Depending on the compatibility, this could result in a very strong bond between the soft and hard materials.

The pad materials could also be joined to the native plastics or metals through mechanical holds or locks. For example, the hard plastic or metal on the case of the laptop computer or other electronic devices could have holes formed in it. The soft elastomer material would flow into these holes and effectively tie down the soft surface. The design and layout of these holes, channels and/or locks could be specific to the device and its dimensions. Overmolded or comolded parts could also be mechanically attached to the surface of the laptop computer or other electronic device through the use of channels, posts, locks and/or snaps.

An elastomeric paint could be used to cover the surfaces of the laptop computer or portable electronic device. The advantages to painting include ease of use and the ability to cover complicated surfaces.

The pad materials could be attached with adhesives. The first type of adhesive would be a liquid or gel glue. The glue would be applied to the hard surface of the computer laptop or other electronic device and/or the soft surface of the hand pads. It is anticipated that some treatment of the surfaces may be required to ensure a quality bond. The soft material would then be pressed onto the glue and hard surface. The second type would be a repositionable adhesive, possibly in the form of a double sided tape. The first side of the tape would contain a strong adhesive for permanent bonding to the soft hand pad. The second side of the tape would contain a weaker, repositionable adhesive covered by a tape liner or release sheet. In this way, the user could simply peel the tape liner off and stick the soft material pad to the surface of his or her laptop computer or other electronic device. The pads could be pulled on and off and repositioned a number of times.

It is anticipated that various modifications may be used regarding the soft hand pad product. These would include the use of various colors in the materials. Thermochromic agents might also be used. These agents would allow the material to change color while subjected to use and different environments.

While various preferred embodiments have been shown and described, it will be understood that there is no intent to limit the invention by such disclosure, but rather, is intended to cover all modifications and alternate constructions falling within the spirit and scope of the invention.

I claim:

1. A laptop computer, comprising:
a one-piece, unitary keyboard housing and a monitor, the keyboard housing supporting a plurality of keys for manipulation by a user of the computer; and
at least one pad selectively secured to the keyboard housing, the at least one pad being positioned adjacent the plurality of keys for supporting the hand of a user as the user manipulates the plurality of keys;
wherein the pad is a substantially flat pad, the pad includes a bottom surface shaped and dimensioned to rest firmly upon the keyboard housing and a top surface contoured to comfortably support a hand of a user, the pad also includes a phase change material incorporated therein, the phase change material absorbing and storing heat for later release in a manner providing a user with a sensation of coolness as he or she places fingers, hands or arms on the pad to provide a comfortable temperature pleasing to a user.

2. The laptop computer according to claim 1, wherein the pad is a viscoelastic solid-phase material.

3. The laptop computer according to claim 2, wherein the viscoelastic solid-phase material is a thermoplastic elastomer.

4. The laptop computer according to claim 1, wherein the viscoelastic material is a viscous liquid material contained within an elastomeric bag.

5. The laptop computer according to claim 1, wherein the phase change material is incorporated in a coating on the pad.

6. The laptop computer according to claim 5, wherein the coating is a fabric, leather or foam having phase change material incorporated therein.

7. The laptop computer according to claim 1, wherein the pad includes a core, and the phase change material is incorporated in the core of the pad.

8. The laptop computer according to claim 1, wherein the pad also includes an adhesive layer applied to the bottom surface allowing for ready attachment to the laptop housing.

9. A pad adapted for or use with a laptop computer, personal digital assistant or other electronic devices, comprising:
a flat viscoelastic pad, the pad includes a bottom surface shaped and dimensioned to rest firmly upon a machine housing and a top surface contoured to comfortably support or grip a hand of a user;
the pad including a phase change materials, natural material or synthetic material providing a user with a pleasant sensation or a feeling of coolness as he or she places fingers, hands or arms on the pad.

10. The pad according to claim 9, wherein the pad is a viscoelastic solid-phase material.

11. The pad according to claim 9, wherein the pad includes leather or synthetic leather material.

12. The pad according to claim 9, wherein the viscoelastic material is a viscous liquid material contained within an elastomeric bag.

13. The pad according to claim 9, wherein the phase change material is incorporated in a coating on the pad.

14. The pad according to claim 13, wherein the coating is a fabric, leather or foam having phase change material incorporated therein.

15. The pad according to claim 9, wherein the pad includes a core, and the phase change material is incorporated in the core of the pad.

16. The pad according to claim 9, wherein an adhesive layer is applied to the bottom surface of the pad, the adhesive allowing for ready attachment of the pad to the laptop housing

17. The pad according to claim 16, further including a release sheet covering the adhesive layer such that the adhesive layer may be protected until such a time that one desires to apply the pad to the laptop computer, personal digital assistant or other electronic device.

18. A laptop computer, comprising:
a housing including an input device and a monitor coupled thereto; and
at least one pad selectively secured to the housing where the user rests his or her hands or grabs the laptop computer.
wherein the pad is a substantially flat pad, the pad includes a bottom surface shaped and dimensioned to rest firmly upon the housing and a top surface designed to comfortably support a hand or fingers of a user and for additional comfort and tactile benefits.

19. The laptop computer according to claim 18, wherein the pad includes a viscoelastic solid-phase material.

20. The laptop computer according to claim 18, wherein the pad includes leather or synthetic leather materials.

21. The laptop computer according to claim 18, wherein the viscoelastic material is a viscous liquid material contained within an elastomeric bag.

22. The laptop computer according to claim 18, wherein the pad also includes an adhesive layer applied to the bottom surface allowing for ready attachment to the laptop case.

23. A pad adapted for selective attachment to or use with a laptop computer, personal digital assistant or other electronic devices, comprising:
a flat viscoelastic pad, the pad includes a bottom surface shaped and dimensioned to rest firmly upon a machine housing and a top surface contoured to comfortably support a hand of a user; and
the pad includes a bottom surface shaped and dimensioned to rest firmly upon the keyboard housing and a top surface contoured to comfortably support a hand of a user and regulate the temperature of the hand pad as a user places fingers, hands or arms on the hand pad, and the top surface is leather or synthetic leather.

24. The pad according to claim 23, wherein the pad includes a core that is a viscoelastic solid-phase material.

25. The pad according to claim 24, wherein the viscoelastic solid-phase material is a styrenic thermoplastic elastomer.

26. The pad according to claim 23, wherein the viscoelastic material is a viscous liquid material contained within an elastomeric bag.

27. The pad according to claim 23, wherein an adhesive layer is applied to the bottom surface of the pad, the adhesive allowing for ready attachment of the pad to the laptop housing.

28. The pad according to claim 27, further including a release sheet covering the adhesive layer such that the adhesive layer may be protected until such a time that one desires to apply the pad to the laptop computer, personal digital assistant or other electronic device.
